(19) United States
(12) Patent Application Publication
(10) Pub. No.: US 2025/0337291 A1
(43) Pub. Date: Oct. 30, 2025

(54) METHOD FOR PRODUCING A STATOR OF A DYNAMOELECTRIC MACHINE

(71) Applicant: Innomotics GmbH, 90441 Nürnberg (DE)

(72) Inventors: TOBIAS KATZENBERGER, Bad Königshofen STT Unteressfeld (DE); BASTIAN PLOCHMANN, Neustadt an der Aisch (DE)

(73) Assignee: Innomotics GmbH, 90441 Nürnberg (DE)

(21) Appl. No.: 18/867,312

(22) PCT Filed: May 3, 2023
(86) PCT No.: PCT/EP2023/061642

§ 371 Date: Nov. 19, 2024

(30) Foreign Application Priority Data
May 24, 2022 (EP) 22175168.8

(51) Int. Cl. H02K 1/16; H02K 3/12; H02K 5/04

(52) U.S. Cl. CPC H02K 1/16; H02K 3/12; H02K 5/04

(57) ABSTRACT

In a method for producing a stator of a dynamoelectric rotating machine a winding system is arranged in a magnetically conductive body in grooves facing an interior bore such as to create respective winding heads on end faces of the magnetically conductive body. The magnetically conductive body is connected for conjoint rotation to a housing which extends axially, on both sides of the magnetically conductive body, at least to an axial outer edge of the winding heads so as to create a circumferential gap arranged between a radial outer side of the winding heads and an inner edge of the housing and filled with a potting compound to thermally connect the winding heads to the housing. The potting compound penetrates radial outer regions of the winding heads to such an extent that the potting compound is prevented from escaping at a radial inner edge of the winding heads.

The Invention relates to a method for producing a stator of a dynamoelectric rotating machine, as well as a dynamoelectric rotating machine with such a stator and the use of such a dynamoelectric rotating machine.

Dynamoelectric machines have a stator with a magnetically conductive body. In this body, in particular an axially layered laminated core, a winding system is provided in essentially axially extending grooves facing a rotor. During operation of the dynamoelectric machine, this winding system causes the rotation of the rotor by means of electromagnetic interaction. The winding system has electrical conductors which are, for example, round enameled wires. These wires are positioned in the respective groove in a variety of ways, for example by means of draw-in or trickling methods, Winding heads are formed on the end faces of the stator.

The enamel on the wires corresponds to the main insulation in the application area of low-voltage motors, e.g. up to 1 KV. Nevertheless, further Impregnation or potting is usually carried out for further mechanical strengthening and passivation against external influences.

Dynamoelectric rotating machines in the low voltage range <1 kV in the performance classes 0.5 KW to 2000 KW are impregnated by means of cold dipping methods, or hot dipping methods (e.g. current-UV method) for reasons of cost. In this process, the stators are immersed in a basin of liquid resin and then thermally cured. The geometric intermediate spaces of the winding in the groove of the stator are predominantly filled with resin and thus strengthened, additionally electrically insulated and thermally connected to the laminated core.

The winding heads, i.e. the necessary conductor strands, which connect the active areas of the conductors in the grooves to one another, are located in the end-face areas of the stators. Prior to the impregnation method, the winding heads are again equipped with surface insulating materials (e.g. insert papers) in order to electrically insulate different electrical phases of the dynamoelectric machine from one another. Furthermore, the winding head is pressed into shape, compressed and bandaged in order to comply with predetermined geometric dimensions and not exceed a designated axial overall length.

A thermal connection of the winding heads to a housing is provided exclusively via an intermediate space which is filled with air. Heat dissipation from the winding head thus takes place extremely inadequately via the thermal contact transitions from the winding to the air and further from the air to the housing. This is a critical factor which above all limits the performance class of a motor as so-called hotspots can occur in the winding head in particular. Due to the comparatively high current in the winding system and the additional geometric and mechanical compression or fixation of the winding system in the winding head necessary, areas are created which become significantly hotter than within the stator grooves. In the grooves of the stator, heat dissipation via the surrounding sheet iron is very efficient.

Possible heat dissipation of the winding head within a low-voltage motor is achieved by means of variable-speed impellers, which are mounted directly on the shaft and drive air convection in proportion to the speed of the motor, so that convective air flows around the winding head. However, this ventilation in turn has a negative effect on the performance and efficiency of the motor and is complex to manufacture and produce as well as comparatively cost-intensive.

If better heat dissipation properties are necessary due to higher performance requirements for the dynamoelectric machine, the winding head must be thermally connected to the housing by means of “winding head potting”.

In addition to the material costs, the processing costs of winding head potting are significantly higher as the impregnated stators have to be removed from the standard production flow and prepared for winding head potting using potting molds (first one side, then the other). This involves introducing a kind of internal mandrel into the interior bore of the stator in a form-fitting manner and heating the stator to a higher temperature if necessary (e.g. 80° C., to improve the flowability of the potting compound). The potting compound is then poured into the winding head reservoir enclosed in this way. The compound is then cured for several hours at approx. 150° C., e.g. in a hot air oven. After curing—and cooling—the other side of the winding head is processed in the same way.

After the two individual processes, the potting body thus encloses both winding heads both radially on the inside and radially on the outside, whereas the heat flow in the closed motor occurs predominantly radially outwards towards the housing, Rather, the complete enclosure is a phenomenon due to the process, as the Internal mandrel serves as the housing wall of the potting and must be removed and cleaned afterwards.

Overall, this is a very complex manufacturing process which requires time, energy and material costs. In addition, this manufacturing process results in unnecessary material in the motor, which is irrelevant for the functioning of the motor.

DE 693 07 422 T2 discloses an electric motor with a completely cast-in winding system using cores.

DE 199 57 942 C1 discloses a high-frequency motor spindle, the winding head of which is surrounded by a U-shaped hollow body, a free space between the winding head and the hollow body being cast out.

DE 199 02 837 C1 discloses a rotating electric machine, the winding head of which is thermally coupled to a supporting body via thermal bridges, the thermal bridge comprising a solid ring and a cast resin body.

However, the listed known solutions for heat dissipation of the winding head of a stator of a dynamoelectric rotating machine are comparatively complex, in particular when it comes to dynamoelectric machines which are to be produced in larger quantities.

On this basis, the object of the invention, inter alia, is to create a dynamoelectric machine which has sufficient cooling, in particular good thermal heat dissipation of the winding head of a stator of a dynamoelectric machine, with comparatively little manufacturing effort.

The set object is achieved by a method for producing a stator of a dynamoelectric rotating machine by way of the following steps:
arranging a winding system in a magnetically conductive body, in particular an axially layered laminated core in grooves facing an Interior bore, so as to create a respective winding head on the end faces of the magnetically conductive body,
connecting the magnetically conductive body to an in particular thermally conductive housing for conjoint rotation, wherein the housing extends axially, on both sides of the laminated core of the stator, at least as far as the axial outer edge of the respective winding head, resulting in the creation of a respective circumferential gap between a radial outer side of the winding head and an inner edge of the housing in the region of the winding heads,
filling this circumferential gap between the radial outer side of the winding head and the inner edge of the housing with a potting compound, having at least one theologically optimized additive so as to thermally connect the winding head to the housing

The set object is also achieved by a dynamoelectric rotating machine, with a stator with a magnetically conductive body, in particular an axially layered laminated core, wherein a winding system is arranged in grooves facing an Interior bore of the stator, which forms a winding head for each of the end faces of the magnetically conductive body,

wherein a connection is provided between the magnetically conductive body and an in particular thermally conductive housing for conjoint rotation,
wherein the housing extends axially on both sides of the magnetically conductive body of the stator, at least up to the axial outer edge of the respective winding head, wherein the circumferential gap in the region of the winding heads between a radial outer side of the winding head and an inner edge of the housing is filled with at least one theologically optimized additive by means of a potting compound, so as to thermally connect the winding head to the housing,
and a rotor, the stator and rotor being spaced apart by an air gap.

The winding system of the stator is considered to be the entirety of the electrical conductors, including any insulation. The conductors can be shaped coils, round or flat wires with or without insulation. Single-phase, three-phase or multi-phase systems are also included. In terms of winding technology, both toothed coil technology and chorded windings or lap winding are also included. The decisive factor is always that the winding head formed by any winding system is thermally coupled directly to a housing.

According to the invention, the winding head is now thermally connected to a housing surrounding the winding head. This is achieved by a targeted dispensing process of the thermally conductive, flowable compound into a circumferential gap between the winding head and the housing. The thermally conductive potting compound is characterized by the following process-optimized properties.

The potting compound is a molding material filled with thermally conductive particles (reactive resin, e.g. epoxy, polyurethane or polyester. The filler particles are dispersed as microparticles in the matrix (reactive resin) depending on the desired thermal conductivity and the desired price level of the molding material, inter alia from quartz powder, fused silica, boron nitride or aluminum oxide in an optimized particle size distribution, so that the molding compound that is present is still as fluid and flowable as possible. The filling level of the filler in the matrix is between 20 and 70% by volume, depending on the desired flowability at processing temperature.

In addition to being filled with the above-mentioned thermally conductive particles, the potting compound is equipped with a rheology-optimizing additive. This additive causes the flowability of the potting compound to assume thixotropic and structurally viscose properties and thus significantly reduces its viscosity at an increased shear rate (which is achieved by dispensing through an automatic dispensing machine, a dosing unit) and then returns to significantly higher viscosities at low shear rates. It is thus possible to gradually fill the area, in particular the gap between the winding head and the housing, using a dosing unit equipped for this purpose to fill the stator standing perpendicularly. The flowing potting compound reduces its viscosity due to the shear forces which occur during dispensing, is distributed homogeneously in the target area and encloses the individual wires of the winding head in a form-fitting manner.

As the flow process between the groove outlets becomes ever slower, the viscosity increases due to the decreasing shear forces, which leads to the flow front between the groove outlets solidifying on its own.

Filling/casting of the intermediate space between the winding head and the housing is thus possible without any additional housing, i.e. an internal mandrel for the interior bore of the stator.

A typical example of a thixotropic additive is pyrogenic silica (silica gel), which is dispersed in the potting compound (0.1-1% by weight) to obtain these required properties.

Another material property of the potting compound is that it is a two-component reactive resin which is mixed in-situ in the dosing unit (resin and hardener component). This ensures that the potting compound sets within a comparatively short time (a few hours to only a few minutes) without any further temperature input. The basic viscosity of the potting compound increases due to the chemical network formation in such a way that the production flow is not interrupted and further work on the stator or the dynamoelectric machine is possible.

A temperature input into this process would reduce viscosity and would therefore not be practicable, as otherwise the potting compound without housing or an internal mandrel would migrate, inter alia, between the groove outlets and flow into the inner radius, i.e. the Interior bore of the stator.

The aim is then to cure the stator in the housing at room temperature within 24 hours, which is achieved using 2-component epoxies with amine hardener components, for example.

With the invention mentioned here, the process of thermally connecting the winding head to the housing can be made significantly more cost-efficient with regard to cycle times, energy input (room temperature) and process complexity than with conventional connections known from the prior art.

Thus, the achievement of higher performance classes or a longer service life of a dynamoelectric machine can be produced significantly more cost-effectively with the same electrical and thermal load.

According to the invention, the combination of the following parameters leads to tool-free potting of the stator of a dynamoelectric machine.

The potting compound is thixotropic and highly filled, so that a high basic viscosity is achieved under shear and an even higher resting viscosity is achieved after a few seconds/minutes of rest. This allows the potting compound to flow and nestle pore-free into the area between the outer radius of the winding head and the housing, the areas between the groove outlets are filled, a “solidifying” flow front being created due to the rheology in such a way that no tool in the form of a jacket-shaped potting mold is required in the area of the stator bore (i.e. no potting compound to be sealed escapes at the Inner radius of the winding head).

The potting material consists of a highly reactive system, which at least gels at room temperature and thus loses its flowability (preferably 2K, ideally hardening within several hours/a few days). This avoids the need to increase the temperature for gelling/curing, which would inevitably lead to a reduction in viscosity and would again necessitate a potting mold for sealing.

The invention and further advantageous embodiments of the invention are explained in more detail with reference to exemplary embodiments illustrated in principle, in which:

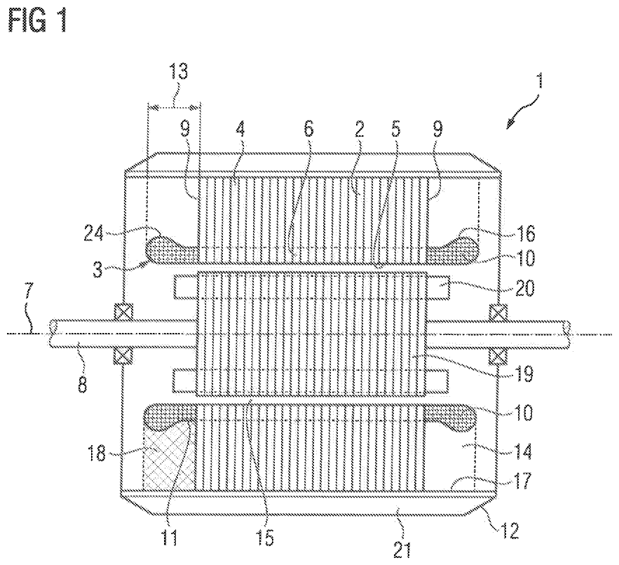

FIG. 1 shows a principal longitudinal section of a dynamoelectric rotating machine,

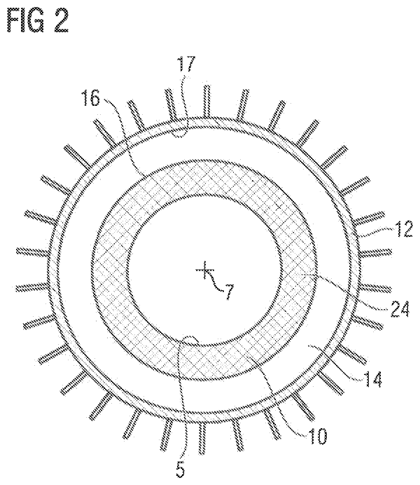

FIG. 2 shows a side view of a stator in the housing,

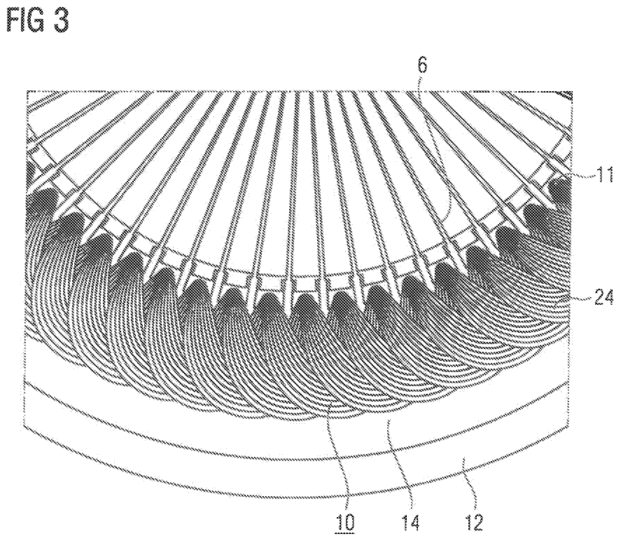

FIG. 3 shows a partial perspective view of a stator in the housing,

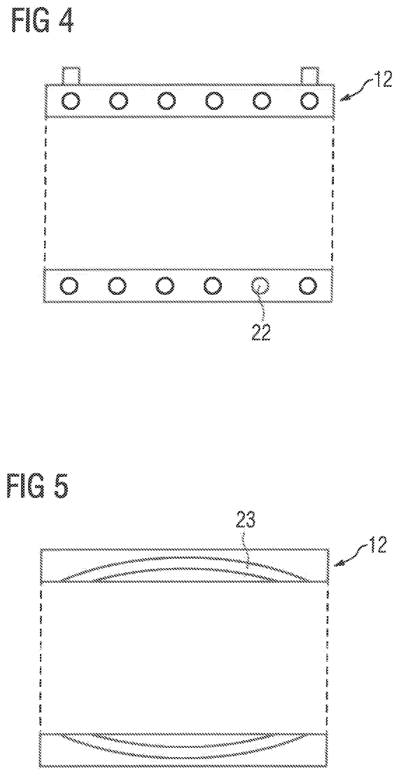

FIGS. 4,5 show further housing embodiments.

It should be noted that terms such as “axial”, “radial”, “tangential”, etc. refer to the axis 7 used in the respective figure or in the example described in each case. In other words, the directions axial, radial, tangential always refer to an axis 7 of the rotor 19 and thus to the corresponding axis of symmetry of the stator 2. Here, “axial” describes a direction parallel to the axis 7, “radial” describes a direction orthogonal to the axis 7, towards it or away from it, and “tangential” is a direction which is directed in a circle around the axis 7 at a constant radial distance from the axis 7 and in a constant axial position. The term “in the circumferential direction” is to be equated with “tangential”.

With regard to an area, for example a cross-sectional area, the terms “axial”, “radial”, “tangential”, etc. describe the orientation of the normal vector of the area, i.e. the vector which is perpendicular to the area in question.

The term “coaxial components”, for example coaxial components such as a rotor 19 and a stator 2, is here understood to mean components which have the same normal vectors, i.e. for which the planes defined by the coaxial components are parallel to one another. Furthermore, the term is intended to mean that the centers of coaxial components lie on the same axis of rotation or axis of symmetry. However, these centers may be located at different axial positions on this axis, and the planes mentioned may therefore be at a distance >0 from one another. The term does not necessarily require that coaxial components have the same radius.

In the context of two components which are “complementary” to one another, the term “complementary” means that their outer shapes are designed in such a way that one component can preferably be arranged completely in the component which is complementary to it, so that the inner surface of one component and the outer surface of the other component ideally contact each other without gaps or over their entire surface. Consequently, in the case of two mutually complementary objects, the external shape of one object is determined by the external shape of the other object. The term “complementary” could be replaced by the term “inverse”.

For the sake of clarity, often not all of the components shown in the figures are marked with reference characters in cases in which there are multiple components.

The embodiments described can be combined as desired. Likewise, individual features of the respective embodiments can also be combined with one another, without departing from the essence of the invention.

The winding system 3 of the stator 2 is considered to be the entirety of the electrical conductors, including any insulation. The conductors can be shaped coils, round or flat wires with or without insulation. Single-phase, three-phase or multi-phase systems are also included. In terms of winding technology, both toothed coil technology and chorded windings or lap winding are also included. The decisive factor here is always that the winding head 10 formed by any winding system 3 is thermally coupled directly to a housing 12.

FIG. 1 shows a basic longitudinal section of a dynamoelectric rotating machine 1, which is fixed in a housing 12 so that it cannot rotate. A stator 2, which is designed as a magnetically conductive body, in particular as a laminated core 4, has a winding system 3 in grooves 6 pointing towards an air gap 15 of the dynamoelectric machine 1. The winding system 3 forms a winding head 10 comprising a bead 24 and a winding neck 11 on each of the end faces of the stator 2. The winding neck 11 refers to the section of the winding head 10 which forms the section of the winding system 3 immediately after leaving the groove 6, in which the electrical conductors still run essentially axially before forming the bead 24.

The winding head 10 of the winding system 3 has an axial extension 13 which corresponds to the subsequent filling level of the potting compound 18. Between the inner edge 17 of the housing 12 and the outside of the winding head 10 of the winding system 3 there is a gap 14, which is filled with a potting compound 18, which will be described in more detail later.

A rotor 19 is arranged at a distance from an air gap 15 of the stator 2, which is connected to a shaft 8 in a torque-proof manner and is rotatably mounted around an axis 7. In this case, the rotor 19 is laminated and has a squirrel cage 20 arranged in the laminated core. The housing 12 has ribs 21, at least in sections, on the outer circumference.

The axial extension 13 of the gap 14 is now filled with a potting compound 18, so that at least the outside of the winding head 10 of the winding system 3 is thermally well connected to the housing 12. Due to the material properties of the potting compound 18, it penetrates at least the radial outer areas of the winding head 10, but only to such an extent that no potting compound escapes from the radial inner area of the winding head 10.

FIG. 2 shows a side view of the stator 2, which is positioned in the housing 12 with its winding system 3, which forms the winding head 10 on the end face of the stator 2. The gap 14 is filled by the potting compound 18. In particular, the stator 2 is positioned in a perpendicular or inclined manner. First, one end face of the stator is provided with potting compound 18, then the other end face is filled with potting compound 18.

The filling of the stator 2 in the perpendicular or Inclined state described above requires serial processing of the respective end faces. Depending on the dimensions of the gap 14 (depending, inter alia, on the type of motor), approx. 15 to 30 minutes must be allowed between the end of filling on one end face and the start of filling on the other end face at room temperature.

Due to the material properties of the potting compound 18, it penetrates the winding head 10, I.e. the bead 24 and the winding neck 11, only to the extent that the interior bore 5 remains free of potting compound 18. This simplifies the production and potting of the winding system 3 in a simple manner. Furthermore, the thermal connection of the winding head 10 to the housing 12 is improved.

FIG. 3 shows a partial perspective view of a section of the stator 2, which is positioned in the housing 12. The stator 2 is provided with the winding system 3. The winding necks 11, whose electrical conductors run axially, can be seen axially outside the laminated core 4 of the stator 2. In the bead 24 of the winding head 10, these conductors then bend to lead into other grooves 6. The packing density of the conductors of the winding system 3 increases radially inwards In the bead 24, so that the increasingly narrow capillaries between the conductors of the potting compound 18, in addition to the decreasing viscosity, also make it more difficult to penetrate radially inwards via the winding head 10.

Due to the good thermal conductivity of the individual conductors lying next to one another, in particular copper conductors, a comparatively acceptable thermal conductivity to the outside is nevertheless given within the bead 24, even if the individual conductors are not directly surrounded by potting compound 18.

Due to the mutual contact of the electrical conductors, thermal conductivity also occurs here radially outwards into the area of the winding head 10, which is pressurized with the thermally conductive potting compound 18.

The potting compound 18 uses a molding material filled with thermally conductive particles (reactive resin, e.g. epoxy, polyurethane or polyester). Depending on the desired thermal conductivity of the potting compound, these filler particles, including quartz powder, fused silica, boron nitride or aluminum oxide, are dispersed in an optimized particle size distribution as microparticles in a matrix (reactive resin), so that a flowable molding compound with the lowest possible viscosity is still present. The filling level of the filler in the matrix is between 20 and 70% by volume, depending on the desired flowability at processing temperature.

In addition to being filled with the above-mentioned thermally conductive particles, the potting compound 18 is provided with a rheology-optimizing additive according to the invention. This additive causes the flowability of the potting compound 18 to assume thixotropic and structurally viscous properties and thus significantly reduces its viscosity at an increased shear rate and subsequently returns to significantly higher viscosities at low shear rates. This makes it possible to gradually fill the area, in particular the gap 14 between the winding head 10 and the inner edge 17 of the housing 12 by means of a dosing unit equipped for this purpose, the stator 2 preferably standing perpendicularly up to the axial extension 13 of the winding head 10. The flowing potting compound 18 reduces its viscosity due to the shear forces occurring during dispensing, distributes itself homogeneously in the gap 14 and encloses the individual wires of the winding head 10 in a form-fitting manner.

As the flow process between and within the winding necks 11 and in the bead 24 becomes ever slower, the viscosity continues to increase due to the decreasing shear forces, which leads to independent solidification of the flow front of the potting compound 18 between the winding necks 11.

Filling/casting of the intermediate space or the gap 14 between the winding head 10 and the housing 12 is therefore possible without additional housing, i.e. an internal mandrel for the interior bore of the stator 2.

A typical example of a thixotropic additive is pyrogenic silica (silica gel), which is dispersed in the potting compound 18 (0.1-1% by weight) to obtain these desired properties.

Another material property of the potting compound 18 is that it is a two-component reactive resin which is mixed in-situ in a dosing unit (resin and hardener component). This ensures that the potting compound 18 sets within a comparatively short time (a few hours to only a few minutes) without any further temperature input. The basic viscosity of the potting compound 18 increases due to the chemical network formation in such a way that the production flow is not interrupted and further work on the stator 2 or the dynamoelectric machine 1 is possible.

A temperature input into this process would reduce viscosity and would therefore not be practicable, as otherwise the potting compound 18 without housing or an internal mandrel would migrate, inter alia, between the winding necks 11 and/or the bead 24 and flow into the inner radius, i.e. the interior bore of the stator 2.

In principle, the housing 12 can be made of aluminum or other thermally conductive materials. Furthermore, it can be equipped with ribs 21, at least in sections, to further improve cooling.

FIG. 4 shows a housing 12 with exemplary means for liquid cooling 22. In this case, helical cooling tubes are arranged in the housing 12. This improves the cooling of the dynamoelectric machine 1, in particular the stator 2 and there especially the winding head 10.

FIG. 5 shows a further possibility for designing the housing 12, which now offers the possibility of a closed internal air cooling circuit. In this case, air is conveyed into the interior of the machine 1 via a fan arranged inside the housing 12, inter alia via the winding heads 10.

Such dynamoelectric rotating machines 1 are used as fans, compressors, pumps, etc. in industry, food production, and in traffic engineering due to their simple design and efficiency.

1.-12. (canceled)

13. A method for producing a stator of a dynamoelectric rotating machine, the method comprising:
arranging a winding system in a magnetically conductive body in grooves facing an Interior bore such as to create respective winding heads on end faces of the magnetically conductive body;
connecting the magnetically conductive body for conjoint rotation to a housing which extends axially, on both sides of the magnetically conductive body, at least to an axial outer edge of the winding heads so as to create a circumferential gap between a radial outer side of the winding heads and an inner edge of the housing in a region of the winding heads; and
filling the circumferential gap with a potting compound, having a theologically optimized additive, so as to thermally connect the winding heads to the housing, with the potting compound penetrating radial outer regions of the winding heads to such an extent that the potting compound is prevented from escaping at a radial inner edge of the winding heads.

14. The method of claim 13, wherein the magnetically conductive body is an axially layered laminated core.

15. The method of claim 13, wherein the housing is thermally conductive.

16. The method of claim 13, further comprising shrink-fitting the magnetically conductive body into the housing,

17. The method of claim 13, wherein the winding system has preformed shaped coils or wires.

18. The method of claim 13, wherein silica is used as the additive.

19. The method of claim 13, wherein pyrogenic silica is used as the additive.

20. The method of claim 13, wherein the potting compound comprises a two-component reactive resin and/or a filler to increase overall viscosity and thermal conductivity.

21. The method of claim 13, wherein the stator is filled with a vertical axis or with an inclination of the axis of max. 45 degrees.

22. A dynamoelectric rotating machine, comprising:
a housing;
a stator connected to the housing for conjoint rotation, said stator including a magnetically conductive body and a winding system which is arranged in grooves of the magnetically conductive body in facing relation to an interior bore of the stator, and which includes conductors arranged in the grooves at a packing density which increases radially inwards, said winding system forming a winding head on end faces of the magnetically conductive body, with the winding head including a bead and a winding neck, wherein the housing extends axially on both sides of the magnetically conductive body at least to an axial outer edge of the winding heads so as to create a circumferential gap between a radial outer side of the winding heads and an inner edge of the housing in a region of the winding heads;
a potting compound having a rheologically optimized additive for filling the circumferential gap so as to thermally connect the winding heads to the housing, with the winding heads having an axial extension which corresponds to a filling level of the potting compound, wherein the interior bore of the stator is free of potting compound; and
a rotor arranged in spaced-apart relation to the stator to define an air gap there between.

23. The dynamoelectric rotating machine of claim 22, wherein the magnetically conductive body is an axially layered laminated core.

24. The dynamoelectric rotating machine of claim 22, wherein the housing includes ribs having at least one section which projects when viewed in a circumferential direction and/or axial direction.

25. The dynamoelectric rotating machine of claim 22, wherein the housing is designed to include a water jacket cooling or a closed internal air cooling circuit.

26. The dynamoelectric rotating machine of claim 22, wherein the housing is made of aluminum or another thermally conductive material.

27. The dynamoelectric rotating machine of claim 22, manufactured by the method set forth in claim 13 for use as a drive in fans, compressors and pumps.
